(19) United States
(12) Patent Application Publication
(10) Pub. No.: US 2014/0319049 A1
(43) Pub. Date: Oct. 30, 2014

(54) METHOD OF FORMING FORWARD OSMOSIS MEMBRANES AND THE FORWARD OSMOSIS MEMBRANES THUS FORMED

(71) Applicant: Nanyang Technological University, Singapore (SG)

(72) Inventors: Chuyang Tang, Singapore (SG); Changquan Qui, Singapore (SG); Saren Qi, Singapore (SG)

(21) Appl. No.: 14/354,453

(22) PCT Filed: Oct. 29, 2012
(86) PCT No.: PCT/SG2012/000406

§ 371 Date: Apr. 25, 2014

Related U.S. Application Data
(60) Provisional application No. 61/552,178, filed on Oct. 27, 2011.
(60) Provisional application No. 61/552,215, filed on Oct. 27, 2011.

(51) Int. Cl. B01D 69/12; B01D 61/00

(52) U.S. Cl. CPC B01D 69/125; B01D 61/002
USPC 210/489; 427/244

(57) ABSTRACT

There is provided a method of forming forward osmosis (FO) membranes. The FO membrane should have 1) at least one active rejection layer with high water permeability and solute rejection, 2) a support structure or substrate with tailored properties to reduce ICP, and 3) high membrane stability.

### TECHNICAL FIELD

This invention relates to a method of forming forward osmosis membranes and the forward osmosis membranes thus formed.

### BACKGROUND

Forward osmosis (FO) is a membrane process driven by an osmotic pressure difference between a high-osmotic-pressure draw solution (DS) and a low-osmotic-pressure feed solution (FS). Water can be extracted spontaneously from FS to DS under the osmotic pressure gradient across the FO membrane. Unlike pressure-driven membrane processes such as nanofiltration (NF) and reverse osmosis (RO), FO does not require an externally applied mechanical pressure. Thus, FO may offer the advantages of significantly lower energy input for pumping and minimized fouling phenomenon as well as high fouling resistance. This means that FO may significantly reduce energy requirement for pumping compared to the pressure-driven membrane processes such as NF and RO. Additional advantages of FO may include: lower fouling propensity, no required of high pressure and heat (useful where pressure or heat sensitive components are present). This makes FO attractive for water and energy related applications, such as seawater desalination, wastewater treatment, food industry, as well as electricity generation via a derivative pressure retarded osmosis process.

The performance of the FO process is largely determined by the properties of the FO membrane. Theoretically, semi-permeable RO and NF membranes can be used in the FO process. Many early studies focused on testing RO membranes, but revealed that these membranes showed poor water flux as a result of severe internal concentration polarization (ICP) in their support structures. In the 1990s, a process to fabricate FO membranes tailored to minimize ICP was disclosed. In this process, cellulose tri-acetate was used to form a membrane rejection layer by a phase inversion method. The resulting membranes had significantly reduced ICP compared to conventional RO and NF membranes. The main limitations of these FO membranes include 1) relatively low water permeability of the rejection skin, and 2) low chemical resistance to hydrolysis which required the membranes to be used in a narrow pH range.

Subsequently, much research focused on characterization of FO membranes, such as antifouling effect, selection of draw solution, and modeling, etc. Exploration of high performance FO membranes also developed. However, some polymer materials used for FO membrane fabrication, such as celluloses triacetate (CTA), have poor thermal, chemical, and biological stability. The rejection layers of prepared by using the existing fabrication methods showed limited water permeability and sometime moderate solute rejection. Another main drawback of FO is ICP. The effective driving force will be reduced by either the accumulation of solutes from feed water or the dilution of draw solution in the porous support layer in an FO process. Theoretically, conventional NF or RO membranes can be used in an FO process, but their thick sponge-like polymeric layer and reinforcement fabric leads to severe ICP. Mass diffusion between bulk solution and the interior surface of selective layer will be greatly hindered by such substrate.

To date, the water flux of existing FO membranes are low due to two major obstacles: internal concentration polarization (ICP) and membrane fouling problems. Conventional FO membranes with only one active rejection layer require a compromise between long-term flux stability (fouling resistance) and short-term water flux. When the active rejection layer faces the draw solution (Al-DS), water flux reduces dramatically when feed solution contains foulant, since the foulant can penetrate into the porous bottom side of membrane. When the active rejection layer faces the feed solution (AL-FS), the water flux is dramatically reduced by the severe ICP. While the AL-DS orientation has less severe ICP, this orientation unfortunately trends to suffer from severe fouling as a result of exposing the porous support substrate to the foulants contained in the feed solution. On the other hand, the AL-FS orientation tends to have low water flux due to severe ICP.

### SUMMARY

The ideal FO membrane shall have 1) at least one active rejection layer with high water permeability and solute rejection, 2) a support structure or substrate with tailored properties to reduce ICP, and 3) high membrane stability.

A high performance FO membrane was prepared by a layer-by-layer (LbL) assembly technology or method. This FO membrane combined 1) an ultrathin rejection layer which displays high water permeability and salt rejection with 2) a tailored porous polymeric support layer to reduce the tendency of ICP. The support layer may be embedded or cast on a support fabric to further enhance the membrane mechanical strength. The LbL approach can achieve an ultrathin high performance rejection layer while allowing great flexibility for optimization of each structural layer to for desired applications.

This method allows controlled thickness and rejection properties of the active rejection layer, while allows independent optimization of the support structure. The rejection layers prepared have both high water permeability and salt rejection. The support is optimized in terms of pore structures to reduce ICP. The entire membrane may be supported by a fabric support to further enhance the mechanical strength. The resulting FO membranes showed superior water flux and low solute reverse transport.

The layer-by-layer (LbL) technology or method was also used to fabricate double-skinned FO membranes. A dense polyelectrolyte rejection skin or layer is designed for the solute separation, while a second LbL skin or rejection layer is included to prevent foulants penetration into the porous support layer sandwiched between the two skins. Each rejection skin or layer (top or bottom skin or layer) was formed by repeated deposition of oppositely charged polyelectrolytes layers via Layer-by-layer (LbL) assembly method, with a tailored thin and porous support or substrate sandwiched between the two rejection layers. These novel double-skinned FO membranes had high FO water fluxes, low FO salt fluxes, and good fouling resistance. The LbL approach allows flexible optimization of each rejection skin to obtain a desired combination of water flux and solute flux, and rejection layers of both RO-like and NF-like (or a combination of these) can be fabricated.

LbL assembly is a simple but elegant method with good controllability. The separation properties of the rejection layer can be easily tailored by changing number of polyelectrolyte layers, polyelectrolyte deposition conditions, and crosslinking conditions. Double-skinned FO membranes with either NF-like or RO-like skins (or a combination of them) can be fabricated. Therefore, the LbL approach has a great potential for fabricate high performance FO membranes with both high water flux and excellent fouling resistance.

A double-skinned FO membrane, with a dense rejection skin for solute retention and a second skin to prevent foulant penetration into the porous support may solve the dilemma of existing FO membranes where water flux is severely limited by either by internal concentration polarization (ICP) or membrane fouling.

According to a first aspect, there is provided a method of forming a forward osmosis membrane. The method comprises (a) forming a charged substrate; and (b) forming a first rejection layer on a first side of the charged substrate. It is preferable that forming the first rejection layer comprises (b)(i) placing the first side of the charged substrate in contact with a polyelectrolyte solution; and (b)(ii) rinsing the charged substrate in water.

Preferably, forming the charged substrate comprises reinforcing the charged substrate with a fabric selected from one of: a woven fabric and a non-woven fabric.

The polyelectrolyte solution may comprise molecules capable of forming at least one of: strong intermolecular electrostatic interaction and hydrogen bonding. The molecules may be selected from, for example, poly(allylamin Hydrochlorid) (PAH), poly(sodium 4-styrene-sulfonate) (PSS), poly(methacrylic acid) (PMAA), poly(acrylamide) (PAAM), protonated polyvinylamine (PVA) and their derivatives. Preferably, a concentration of the polyelectrolyte solution ranges from 0.01 wt. % to 5 wt. %. Furthermore, ionic strength of the polyelectrolyte solution may range from 0.1 wt. % to 2.0 wt. % and may be adjusted by appropriate addition of an inorganic salt with a concentration ranging from 0 to 2.5M.

The method may further comprise repeating steps (b)(i) and (b)(ii) a number of times such that the first rejection layer formed comprises the number of multi-electrolyte layers.

It is preferable that forming the charged substrate comprises forming a neutral substrate via phase inversion followed by treating the neutral substrate with a solution to form one of: a positively charged substrate and a negatively charged substrate.

It is also preferable that forming the charged substrate comprises forming one of: a positively charged substrate and a negatively charged substrate via phase inversion using one of: a positively charged polymeric material and a negatively charged polymeric material respectively.

The method may further comprise (c) forming a second rejection layer on a second side of the charged substrate. It is preferable that forming the second rejection layer comprises (c)(i) placing the second side of the charged substrate in contact with a polyelectrolyte solution; and (c)(ii) rinsing the charged substrate in water. In the method, steps (c)(i) and (c)(ii) may be repeated a number of times such that the second rejection layer formed comprises the number of multi-electrolyte layers. The method may also comprise cross-linking at least one of: the first rejection layer and the second rejection layer.

According to a second aspect, there is provided a forward osmosis membrane formed according to the aforementioned method. The forward osmosis membrane comprises a charged substrate comprising finger-like pores; and a first rejection layer comprising a number of multi-electrolyte layers formed on a first side of the charged substrate. Preferably, the rejection layer is less than 5 μm thick.

The forward osmosis membrane may have water permeability higher than 2×10⁻¹¹ m/s·Pa, salt permeability lower than 1.2×10⁻⁶ m/s when tested using 500 ppm MgCl₂ solution as a feed solution and a trans-membrane pressure of 689 kPa at 23° C.

It is preferable that the forward osmosis membrane has a water flux higher than 20 L/m²·h and a salt flux lower than 4 g/m²·h when tested with 0 mM and 0.5M MgCl₂ solutions as a feed solution and a draw solution respectively at 23° C.

It is also preferable that the forward osmosis membrane has a water flux higher than 14 L/m²·h and a salt flux lower than 4.5 g/m²·h when tested with distilled water and 0.5M MgCl₂ solution as a feed solution and a draw solution respectively at 23° C.

According to a third aspect, there is provided another forward osmosis membrane formed according to the aforementioned method. The forward osmosis membrane comprises a charged substrate comprising finger-like pores; a first rejection layer comprising a number of multi-electrolyte layers formed on a first side of the substrate, and a second rejection layer comprising a number of multi-electrolyte layers formed on a second side of the substrate.

It is preferable that the first rejection layer is an ultrathin highly selective layer having high water flux and high solute rejection, and that the second rejection layer is a loosely selective layer configured to prevent foulant penetration into the substrate. The first rejection layer and the second rejection layer may be less than 5 μm thick.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a schematic illustration of a cross-flow RO setup for measuring intrinsic separation performance of a membrane;

FIG. 2 is a schematic illustration of a cross-flow FO setup for membrane testing;

FIG. 3 is Scanning Electron Microscope (SEM) micrographs of FO membranes synthesized according to the present invention (a) with a reinforcing woven mesh, and (b) without a woven mesh in the support layer or substrate;

FIG. 4 is Scanning Electron Microscope (SEM) micrographs of (a) a cross-section of a double-skinned membrane according to the present invention and (b) a magnified view of (a);

FIG. 5 is a graph comparing FO fouling of single-skinned and double skinned FO membranes formed according to the present invention; and

FIG. 6 is a flow chart of an exemplary method of the invention.

### DETAILED DESCRIPTION OF EXEMPLARY EMBODIMENTS

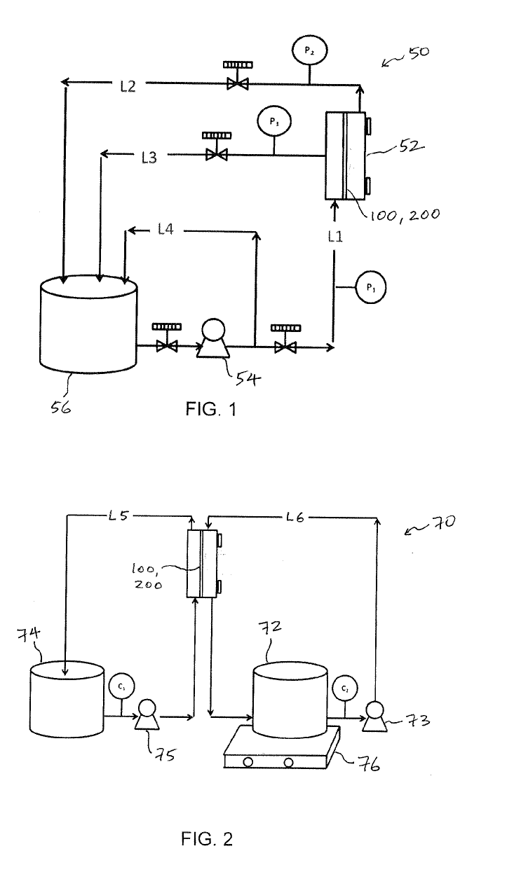

Exemplary embodiments of method 10 of forming forward osmosis membranes 100, 200 and the forward osmosis membranes 100, 200 thus formed will be described with reference to FIGS. 1 to 6 below.

In one embodiment, the method 10 comprises forming or fabricating a high performance FO membrane 100 in two steps: 1) casting or forming a substrate 110 (20) by a phase inversion method, followed by 2) forming a selective rejection layer 120 (30) on the substrate 110 using the LbL method.

Polymers used for casting or forming the substrate 110 can be either charged or neutral. Examples of charged polymers include 1) negative charged polymers such as sulfonated polysulfone (PSF-SO3), sulfonated polyether sulfone (PES-SO3), sulphonated polystyrene, etc, and 2) positive charged polymeric materials such as Polyetherimide (PEI), etc. Where neutral polymers were used to form the substrate 110, the resulting substrate 110 can be pre-treated physically or chemically to impart charged property before assembling the LbL rejection layer.

Examples for substrate pre-treatment for making negative charged polymeric substrates include: using strong alkali solution treat polyacrylonitrile (PAN), using concentrated sulphuric acid to treat polysulfone or polyethersulfone, etc. Examples for substrate pre-treatment for making positively charged polymeric substrates include: using PAH solution reacts with poly(ethylene terephthalate) (PET) to form a positive charged substrate.

The concentration of polymer solution used to prepare the membrane substrate 110 was from 10.0 to 25.0 wt. % (preferably 15.0˜20.0 wt. %). Solvents included 1-Methyl-2-Pyrrolidinone (NMP), dimethyl-acetamide (DMAc), Dimethyl Formamide (DMF), and combination of thereof. Macromolecule organics, small molecule organic and inorganic salts, such as polyvinyl pyrrolidone (PVP), polyethylene glycol (PEG), acetone, isopropanol, ethanol, lithium chloride (LiCl), etc. act as additives to adjust membrane porosity and/or hydrophobicity-hydrophilicity, of which concentration in polymer solution was from 0.1 to 5.0 wt. % (preferably 0.2˜3.0 wt. %). A woven or nonwoven mesh or fabric 130 was made from materials such as polyester (PET), polypropylene (PP), nylon, etc. The mesh 130 had openings from 20 to 90% (preferably 30˜70%) and a thickness from 20 to 120 μm (preferably 20˜50 μm). Room temperature distilled water with certain ratio of solvents was used as a coagulant bath. The added solvents were selected from NMP, DMAc, DMF, etc., of which the concentration was from 0 to 30.0 wt. % (preferably 0˜10.0 wt. %).

The polyelectrolyte used in LbL assembly of the selective rejection layer 120 was chosen from molecules that can form strong intermolecular electrostatic interaction or hydrogen bonding, such as poly(allylamin Hydrochlorid) (PAH), poly(sodium 4-styrene-sulfonate) (PSS), poly(methacrylic acid) (PMAA), poly(acrylamide) (PAAM), protonated polyvinylamine (PVA) and derivatives, etc, of which the concentration in polyelectrolyte solution was from 0.01 wt. % to 5 wt. % (preferably 0.1˜2.0 wt. %). Deionized water, acetone, ethanol, etc and combination of thereof were acted as polyelectrolyte solvents for dissolving polyelectrolyte. Inorganic salts were selected from NaCl, MnCl₂, NaBr, CaCl₂ and etc for adjusting the ionic strength in polyelectrolyte solution, which concentration range is from 0 to 2.5M (preferably 0.3˜1M).

During the polymer solution preparation, certain amount of polymer and additives in organic solvent were mixed in seal container at room temperature or heated up to 90° C. (preferably 50˜70° C.) until homogenous to form a dope. The dope was degassed statically in the same container for at least 24 hours after cooling down to room temperature. Three types of substrates 110-1, 110-2, 110-3 were prepared, with woven fabric 131, with nonwoven fabric 132 and without any reinforcing fabric.

For the substrate 110-1a with woven fabric 131, the dope was spread directly on a clean glass plate by an Elcometer 4340 Motorised Film Applicator (Elcometer (Asia) Pte Ltd) to form a liquid film and then a tailored woven mesh or fabric 131 was attached on the liquid surface.

For the substrate 110-1b with nonwoven fabric 132, a tailored nonwoven mesh or fabric 132 was firstly attached to the glass plate. Then a mixture of organic solvents with certain ratio was applied to the surface of the nonwoven mesh 132 in order to remove air in the mesh 132 followed by casting the polymer dope onto the nonwoven fabric 132 by a casting knife.

For the substrate 110-2 without any reinforcing fabric, the dope was directly cast with certain thickness. The resulting polymeric film was immersed into the coagulation water bath quickly and smoothly. After the polymer liquid film had solidified, excess solvent and additives were removed by soaking the substrate in deionized (DI) water before use.

The LbL assembly of the selective rejection layer 120 on a preformed charged membrane substrate 110 was carried out in containers containing polyelectrolyte solutions. The polyelectrolytes were deposited onto the substrate 110 in an alternative sequence by soaking the substrate 110 into different polyelectrolytes. For each soaking, the substrate 110 was placed in a polyelectrolyte solution for 1˜120 minutes (preferably 15˜60 minutes) (32). It 110 was then rinsed with deionized water for 0.5-10 minutes (preferably 1-3 minutes) (34) before soaking into the next electrolyte solution (32). The assembly procedure may be repeated to deposit multi-electrolyte-layers on the substrate 110. After the desired number of layers had been deposited, the membranes 100 formed were soaked in the deionized water before characterization.

The resulting substrates 110-2 without reinforcing fabric 130 had thickness from 50 to 200 μm (preferably 50˜80 μm), pure water flux from 30 to 1000 L/m²·h (preferably 100˜1000L/m²·h) under 100 kPa, mean pore diameter of skin layer from 10 to 100 nm (MWCO 20,000˜70,000 Dalton, dextran), porosity from 30 to 80% (preferably 60˜80%), contact angle from 20 to 150° (preferably 20˜100°). The cross-section of this type of substrates 110-2 was finger-like pores 112 beneath a thin skin layer 120. Thickness of the skin layer 120 was smaller than 5 μm.

The substrates 110-1a, 110-1b with reinforcing fabric 130 had thickness from 25 to 200 μm (preferably 40-170 μm), pure water flux from 30 to 1000 L/m²·h (preferably 100˜1000 L/m²·h) under 100 kPa, mean pore diameter of skin layer from 10 to 100 nm (MWCO 20,000˜70,000 Dalton, dextran), porosity of from 30 to 80% (preferably 40˜80%), contact angle of from 20 to 150° (preferably 20˜100°). The cross-section of this type of substrates 110-1a, 110-1b comprised a thin skin layer 120 and a highly porous support layer 112 bonded to the open mesh 130.

The FO membranes 100-2 without reinforcing fabric 130 had water permeability higher than 2×10⁻¹¹ m/s·Pa, salt permeability lower than 1.2×10⁻⁶ m/s (testing condition: 500 ppm MgCl₂ solution as feed, trans-membrane pressure of 689 kPa, 23° C.). In FO testing, the membrane 100 exhibited water flux higher than 20 L/m²·h and salt flux lower than 4 g/m²·h when both membrane orientations were tested with 0 mM and 0.5M MgCl₂ solutions as feed and draw, respectively, at 23° C.

The FO membrane 100-1a, 100-1b with mesh 130 had water permeability higher than 3×10⁻¹¹ m/s·Pa, salt permeability lower than 1.2×10⁻⁵ m/s (testing condition: 500 ppm MgCl₂ solution as feed, trans-membrane pressure of 689 kPa, 23° C.). In FO testing, the membrane had water flux higher than 14 L/m²·h and salt flux lower than 4.5 g/m²·h when both membrane orientations were tested with distilled water and 0.5M MgCl₂ solution as feed and draw, respectively, at 23° C.

### EXAMPLES

A polymer solution was made with 18 wt. % and 20 wt. % PAN respectively in DMF with 2 wt. % LiCl. Substrates 110-1, 110-2 with and without woven fabric reinforcement 131 were cast respectively. For the first application with a woven fabric reinforcement 100-1, a dope containing 20 wt. % PAN was spread directly on a clean glass plate by a casting knife at a 60 μm gap and then a tailored woven mesh or fabric 131 was attached on the cast film. In the second application without a woven fabric reinforcement 100-3, a dope containing 18 wt. % PAN was spread on a clean glass plate. No reinforcing woven fabric was added. The gap between the casting knife and the glass plate was 175 μm.

Both liquid films (with and without the woven fabric reinforcement) were immediately immersed into a coagulant bath containing room temperature tap water together with the glass plate. After the polymer liquid film solidification, the polymer film was soaked in 1.5M NaOH solution at 45° C. for 1.5 h, then rinsed by DI water until pH was neutral before LbL formation of the selective rejection layer 120.

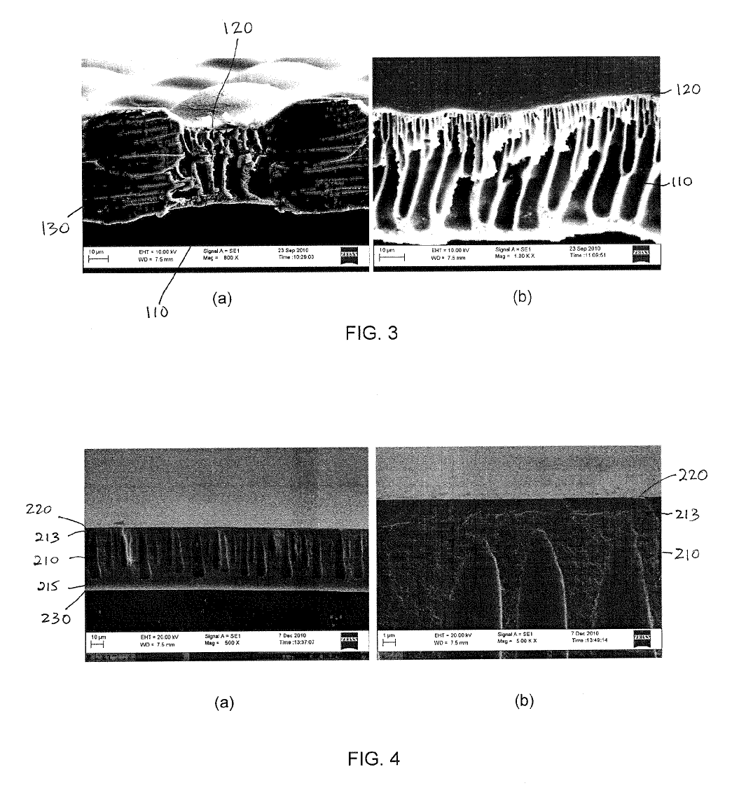

Two polyelectrolyte solutions were prepared for LbL formation of the selective rejection layer 120 on the prepared substrates 110-1, 110-2: 1) 1 g/L poly-(allylamin Hydrochlorid) (PAH) dissolved in 0.5 M NaCl aqueous solution, and 2) 1g/L poly(sodium 4-styrene-sulfonate) (PSS) dissolved in 0.5 M NaCl aqueous solution. The substrate 110-1, 110-2 was first soaked in PAH solution; following rinsed by MilliQ water for 1 minute, and then soaked in PSS solution. The soaking time of each solution was 30 minutes, and the above procedures were repeated three times. The resulting membranes 100-1, 100-2 were soaked in MilliQ water before characterization. FIG. 3 shows the SEM micrographs of the FO membranes 100-1, 100-2 synthesized. The images were taken by a Zeiss Evo 50 Scanning Electron Microscope.

As shown in FIG. 1 an RO setup 50 was provided to evaluate intrinsic separation properties of the FO membranes 100, 200. The membrane coupon 100, 200 was housed in the membrane cell 52 with the active rejection layer facing the feed water inlet. Feed solution was driven by a high pressure pump 54 from a stainless steel tank 56. Pressure transducers P1, P2 and P3 were provided for the feed, permeate and retentate respectively. Route of the feed, permeate, retentate, and by pass are indicated by labels L1, L2, L3 and L4 respectively. Flux was determined gravimetrically by weighing the mass of permeate collected at predetermined time intervals. Conductivity in both permeate and feed was measured in order to determine the rejection. For evaluating pure water flux of substrate, de-ionized water acted as feed solution under 124 kPa, 23° C. For evaluating intrinsic separation properties of FO membranes, 500 ppm aqueous MgCl₂ feed solution through the membrane cell under 0-689 kPa, 23° C. All of the membranes were tested after compaction under 100 kPa until flux became stable.

As shown in FIG. 2, an FO setup 70 was provided to test the FO performance (FO water flux and solute flux) of the membranes 100, 200. The feed solution 72 and draw solution 74 were pumped by two variable-speed peristaltic pumps 73, 75 respectively. Spacers were placed on both sides of the membrane. Permeate flux was determined by a digital mass balance 76 at regular time intervals. Route of the draw and feed solutions are indicated by labels L5 and L6 respectively. Conductivity meters C1 and C2 were provided for both the draw and the feed respectively. Both membrane orientations (active layer facing draw solution (AL-DS) and active layer facing feed water (AL-FW)) were tested. Salt flux was determined by calculating the change of total salt content in feed solution based on conductivity measurement. MilliQ water was used as feed and MgCl₂ solutions with varied concentration from 0.5M to 3.0M were used as draw solution.

Table 1 shows the characteristics of substrates 110-1, 110-2 prepared. Contact angle measurement was performed with Sessile Drop-method, using a Contact Angle System OCA (DataPhysics Instruments GmbH). Pore size of substrate surface was measured with bubble point method, using a Capillary Flow Porometer CFP-1500A (Porous Materials, Inc).

TABLE 1

| | | Jv(LMH) | R | Jv(LMH) | R | Jv(LMH) | R | Jv(LMH) | R | Jv(LMH) | R |
|---|---|---|---|---|---|---|---|---|---|---|---|
| | Description | at 124 kpa | (%) | at 172 kpa | (%) | at 344 kpa | (%) | at 517 kpa | (%) | at 689 kpa | (%) |
| 1 | FO membrane | 10.8 | 79.4 | 19.1 | 85.6 | 28.2 | 90.0 | 40.2 | 91.4 | 51.4 | 92.1 |
| | without mesh | | | | | | | | | | |
| 2 | FO membrane | 30.5 | 54.2 | 32.8 | 59.0 | 45.5 | 61.4 | 55.9 | 62.6 | 79.2 | 64.5 |
| | with woven | | | | | | | | | | |

TABLE 2

| | | | Contact | Pure water | Mean flow |
|---|---|---|---|---|---|
| | | Thickness | angle | flux (L/m2 · | pore diameter |
| | Description | (μm) | (°) | h · bar) | (nm) |
| 1 | Substrate | 61.8 | 27.1 | 421 | 37.2 |
| | without mesh | | | | |
| 2 | Substrate | 60.0 | 57.6 | 319 | 70.7 |
| | with mesh | | | | |

Table 2 shows the intrinsic separation properties of the FO membranes 100-1, 100-2 prepared. The rejection layer 120 of the membranes 100-1, 100-2 had very high water permeability and good solute retention.

Table 3 shows FO performance of the FO membranes 100-1, 100-2 synthesized. For both membranes, decent FO water fluxes (>10 L/m²·h) were achieved with a 0.5 M MgCl₂ draw solution in both membrane orientations. Meanwhile, relatively low solute flux was observed.

TABLE 3

| | | Jᵥ (Draw: | | Jᵥ (Draw: | | Jᵥ (Draw: | | Jᵥ (Draw: | | Jₛ/Jᵥ (Draw: | | Jₛ/Jᵥ (Draw: | | Jₛ/Jᵥ (Draw: | | Jₛ/Jᵥ (Draw: | |
|---|---|---|---|---|---|---|---|---|---|---|---|---|---|---|---|---|---|
| | | 0.5M MgCl₂) | | 1.0M MgCl₂) | | 2.0M MgCl₂) | | 3.0M MgCl₂) | | 0.5M MgCl₂) | | 1.0M MgCl₂) | | 2.0M MgCl₂) | | 3.0M MgCl₂) | |
| | | (L/m² · h) | | (L/m² · h) | | (L/m² · h) | | (L/m² · h) | | (×10⁻² M) | | (×10⁻² M) | | (×10⁻² M) | | (×10⁻² M) | |
| | Descrip- | AL- | AL- | AL- | AL- | AL- | AL- | AL- | AL- | AL- | AL- | AL- | AL- | AL- | AL- | AL- | AL- |
| | tion | DS | FW | DS | FW | DS | FW | DS | FW | DS | FW | DS | FW | DS | FW | DS | FW |
| 1 | FO | 26.5 | 20.9 | 31.2 | 28.0 | 28.3 | 37.6 | 31.0 | 48.4 | 1.5 | 1.2 | 1.6 | 0.7 | 2.5 | 0.7 | 4.8 | 0.7 |
| | membrane | | | | | | | | | | | | | | | | |
| | without | | | | | | | | | | | | | | | | |
| | mesh | | | | | | | | | | | | | | | | |
| 2 | FO | 14.4 | 15.2 | 15.7 | 20.6 | 26.6 | 24.4 | 28.4 | 29.4 | 3.0 | 2.5 | 3.6 | 3.6 | 3.9 | 3.8 | 5.0 | 4.4 |
| | membrane | | | | | | | | | | | | | | | | |
| | with | | | | | | | | | | | | | | | | |
| | woven | | | | | | | | | | | | | | | | |

Jᵥ water flux; Jₛ/Jᵥ solute flux/water flux

In another embodiment, the method 10 comprises fabricating a double-skinned FO membrane 200 in two or three steps: (1) casting or forming the support layer or substrate 210 by a phase inversion method; (2) forming the selective rejection layers 220, 230 using LbL assembly technology on both sides 213, 215 of the support layer or substrate 210; and optionally, (3) post-treatment such as chemical crosslinking.

In order to form the selective rejection layers 220, 230 by depositing the alternatively charged polyelectrolyte (PE) onto the surface of a microporous membrane substrate 210, the polymer candidates for the membrane substrate 210 can be selected from polymeric materials either with positive or negative surface charge. Specifically, for the negatively charged polymer materials, the polymer with that functional group like —SO₃, —COO, and —PO₃ and etc. can be ideal candidates. For example, polymers with —SO₃ functional group include sulfonated polysulfone (PSF-SO₃), sulfonated polyether sulfone (PES-SO₃), sulphonated polystyrene etc. Polymer candidates with carboxylic end groups (—COO) can be selected from acrylonitrile polymer and deratives which contains different amount carboxyl group, etc. Positive charged polymeric materials have functional end groups such as —NH₂ (e.g., Polyetherimide (PEI)). Neutrally charged polymeric substrates can obtain surface charge by applying chemical or physical treatment to form charged property. Examples of such treatment includes using strong alkali solution to treat polyacrylonitrile substrate, using concentrated sulphuric acid to treat polysulfone or polyethersulfone, etc, to impart negative charges to the substrates. Similarly, a neutrally charged surface can gain positive charge, e.g., by treating poly(ethylene terephthalate) (PET) substrate with PAH solution.

Concentration of polymer dope for casting the membrane substrates 210 was from 13.0 to 25.0 wt. % (preferably 15.0˜20.0 wt. %). Solvent included 1-Methyl-2-Pyrrolidinone (NMP), dimethyl-acetamide (DMAc), Dimethyl Formamide (DMF), and combination of thereof. Macromolecule organics, small organic molecule and inorganic salts, such as polyvinyl pyrrolidone (PVP), polyethylene glycol (PEG), acetone, isopropanol, ethanol, lithium chloride (LiCl), etc. act as additives to adjust membrane porosity and/or hydrophobicity-hydrophilicity, of which concentration in polymer solution was from 0.1 to 5.0 wt. % (preferably 0.2˜3.0 wt. %). Room temperature distilled water with certain ratio of solvents was used as a coagulant bath. The added solvents was selected from NMP, DMAc, DMF, etc, of which the concentration was from 0 to 30.0 wt. % (preferably 0˜10.0 wt. %).

The polyelectrolytes used in LbL for formation of the selective rejection layers 220, 230 were chosen from molecules with ability to form ionic bonds and/or hydrogen bonds, such as poly(allylamin Hydrochlorid) (PAH), poly(sodium 4-styrene-sulfonate) (PSS), poly(methacrylic acid) (PMAA), poly(acrylamide) (PAAM), protonated polyvinylamine (PVA) and derivatives, etc, of which the concentration in polyelectrolyte solution was from 0.001 wt. % to 20 wt. % (preferably 0.1˜5 wt. %). Deionized water, acetone, ethanol, etc and combination of thereof were acted as polyelectrolyte solvents for dissolving polyelectrolyte. Inorganic salts were selected from NaCl, MnCl₂, NaBr, CaCl₂, MgCl₂, MgSO₄ and etc. for adjusting the ionic strength in polyelectrolyte solution, which concentration range is from 0.001 M to 2.5 M (preferably 0.3˜1 M).

The crosslink agents used in post-treatment were chosen from those chemicals that can cross-link functional groups of —NH₂, —COO, —SO₃ etc. under controlled conditions. For examples, aldehyde based cross-linkers (such as formaldehyde, glutaraldehyde, etc., of which concentration was from 0.01 wt. % to 10 wt. % (preferably 0.1˜2 wt. %)) was used to crosslink amine and/or carbonyl functional groups. HCl and NaOH were used to for pH adjustment from 1.0 to 9.0 (preferably 2.0˜5.0).

During the polymer solution preparation, certain amount of polymer and additives were mixed in organic solvent in seal container at room temperature or heated up to 90° C. (preferably 50˜70° C.) until homogenous to form a dope. The dope was degassed in the same container for at least 24 hours after cooling down to room temperature. The dope was directly spread on a clean glass plate by an Elcometer 4340 Motorised Film Applicator (Elcometer (Asia) Pte Ltd) with certain thickness and formed a liquid film, and then the glass plate was immersed into the coagulation water bath quickly and smoothly. After the polymer liquid film solidification, it was soaked in deionized water to remove excess solvent and additives to form the substrate 210.

LbL assembly was carried out on preformed charged membrane substrates 210 at room temperature in open containers containing unstirred polyelectrolyte solutions that were prepared fresh each time. In each layer deposition step, the substrates 210 were soaked in a polyelectrolyte solution (with either one skin or both skins exposed to the solution) for 1˜120 minutes (preferably 15˜60 minutes). The samples were then rinsed with deionized water for 0.5-10 minutes (preferably 1-3 minutes). The above deposition of polyelectrolyte layers can be repeated. After the desired number of layers had been deposited, membranes 200 were soaked in the crosslinker solution for 1 min to 2 days (preferably 10 min to 24 hrs). The membranes 200 were then stored in pure water before further characterization.

The resulting support layer or substrate 210 had thickness from 30 to 100 μm (preferably 50˜80 μm), pure water flux from 30 to 1000 L/m²·h (preferably 100˜500 L/m²·h) under 100 kpa, mean pore diameter of skin layer from 10 to 100 nm (MWCO 20,000˜70,000 Dalton, dextran), porosity from 30 to 90% (preferably 60˜85%), contact angle from 20 to 150° (preferably 25˜100°). The cross-section of this type of support layer was finger-like pores 212 between two thin skin layers 220, 230. Thickness of the top skin layer 220 and bottom skin layer 230 were both smaller than 5 μm.

Three types of LbL rejection skins 220, 230 were prepared, NF-like skin without crosslinking, cross-linked NF-like skin, and cross-linked RO-like skin. Double-skin FO membranes 200 with a combination of the above rejection skins were prepared. FO membranes 200 of these type can achieve FO water flux as high as 60 L/m²·h under 0.5 M MgCl₂ draw solution at 23° C.

FIG. 4 shows the SEM micrographs of the double-skinned FO membranes 200 synthesized. The images were taken by a Zeiss Evo 50 Scanning Electron Microscope.

### Example 1

Fabrication of NF-like double-skinned FO membrane without crosslink 200-1 has two steps: support layer 210 formation and LbL process to form the rejection layers 220, 230. In the first step: Polymer solution made of 18 wt. % PAN in DMF with 2 wt. % LiCl. The dope was spread on a clean glass plate by casting knife. The gap between the casting knife and glass plate was 150 μm. Liquid films were immediately immersed into a coagulant bath containing room temperature tap water together with the glass plate. After the polymer liquid film solidification, the polymer film was soaked in 1.5 M NaOH solution at 45° C. for 1.5 hour, and then rinsed by DI water until pH was neutral before LbL, thus forming the substrate 210.

In the second step: two polyelectrolyte solutions were prepared for LbL formation of the rejection layers 220, 230 on the prepared support layer 210. 1 g/L poly-(allylamin Hydrochlorid) (PAH) and 1 g/L poly(sodium 4-styrene-sulfonate) (PSS) was dissolved in 0.5 M NaCl solution respectively. Both sides 213, 215 of the support layer 210 were soaked with PAH solution; following rinsed by DI water for 1 minute, and then were soaked with PSS solution. Absorption time of each solution was 30 minutes and repeated three times (label as 3-3b LbL FO). At this point, the membranes 200-1 were transport to DI water for characterization.

### Example 2

Fabrication of cross linked NF-like double-skinned FO membranes 200 has three steps: support layer 210 formation; LbL process to form the rejection layers 220, 230 and crosslink treatment. The first step for this particular example is the same as mentioned above in example 1.

During the second step, two polyelectrolyte solutions of which 1 g/L poly-(allylamin Hydrochlorid) (PAH) and 1 g/L poly(sodium 4-styrene-sulfonate) (PSS) were dissolved in 0.5 M NaCl solution respectively were prepared. Firstly, the top side 213 of the support layer 210 was touched with PAH solution; following rinsed by DI water for 1 minute, and then was contacted with PSS solution. Absorption time of each solution was 30 minutes and repeated three cycles. Same procedure was done for bottom side 215 of the support layer 210. But repeated cycle was from one to three respectively (labelled as 3-1, 3-2, 3-3 LbL FO respectively).

For comparison, a single-skinned membrane 100 was prepared in which three LbL repeated cycles were applied only on the top side 213 of the support layer 210, while leaving the bottom 215 of the support layer 210 blank (labelled as 3-0 LbL FO), i.e., without a rejection layer 230. At this point, the membranes 200, 100 were transported to the crosslink solution.

During crosslink post-treatment, the membranes 200, 100 were soaked in 1 wt. % glutaraldehyde with pH 2-3 for 2 hrs. Then the membranes 200-2a, 200-2b were transport to be store in DI water till they were to be used.

### Example 3

Fabrication of cross linked RO-like double-skinned FO membrane 200 has three steps: support layer 210 formation; LbL process to form the rejection layers 220, 230 and crosslink treatment. The first step for this particular example is the same as mentioned above in example 1.

During the second step, types and concentration of two polyelectrolyte solutions are the same as example 2. Both sides 213, 215 of the support layer 210 were soaked in PAH solution first, and then rinsed by DI water for 1 minute. This was followed by soaking with PSS solution. Absorption time of each solution was 30 minutes and repeated nine times (labelled as 9-9 LbL FO).

For comparison, a single-skinned membrane 100 was prepared in which nine LbL repeated cycles were applied only on the top side 213 of the support layer 210 with a blank bottom 215 (i.e. to rejection layer 230) of the support layer 210 (labelled as 9-0 LbL FO).

In crosslink post-treatment, the membranes 200, 100 were soaked in 1 wt. % glutaraldehyde with pH 2-3 for 16 hrs. The membranes were stored in DI water before any testing.

The same RO set-up as shown in FIG. 1 was used to test the intrinsic separation properties of the FO membrane 200 and its support. The membrane 200 coupon was housed in the membrane cell and the active layer 220 faced feed water inlet. Then the feed water was divided into retentate and permeate by membrane. Feed solution was driven by a high pressure pump from stainless steel tank. Flux was determined gravimetrically by weighing the mass of permeate collected at predetermined time intervals. For evaluating pure water flux of support layer, de-ionized water acted as feed solution under 2.5 bars, 23° C. All of the membranes 200 were tested after compaction under 2.5 bars until flux became stable.

The same FO set-up as shown in FIG. 2 was used to test the performance of the FO membranes 200. The feed and draw solution was pumped by two variable-speed peristaltic pumps respectively. Two spacers were placed on both sides of the membrane 200 to allow flows both the feed water and the draw solution. Permeate flux was come from weight changes of feed tank determined by a digital mass balance at regular time intervals. Both membrane orientations (active layer facing draw solution (AL-DS) and which facing feed solution (AL-FS)) were tested. Salt flux was determined by calculating the change of total salt content in feed solution by digital conductivity meter. DI water was used as feed and MgCl₂ or NaCl solutions with varied concentration.

Table 4 shows the characteristics of substrates 210 of double-skinned FO membranes 200. The membrane thickness was also measured by a digital microscope (VHX-500F, Keyence, Canada) at least six different locations for each membrane. Membrane zeta potential was determined by an eletrokinetic analyzer (EKA, SurPASS, Anton Paar GmbH, Austria) at pH 5.5 in 10 mM NaCl background solution. Detailed procedures for pure water permeability and porosity measurement have been reported elsewhere. Briefly, the test conditions of pure water permeability coefficient (Aₚ) of PAN substrate are: under pressure of 2.5 bar using DI water as feed. The substrate porosity was determined using gravimetric measurements.

TABLE 4

| | Porosity (%) | Thickness (μm) | ZP * (mV) | Aₚ (m/s Pa) |
|---|---|---|---|---|
| PAN | 73 ± 2 | 55 ± 3 | 12 ± 0.6 | 1.67873E−10 |
| PAN-OH | 73 ± 3 | 55 ± 3 | −32 ± 0.8 | 8.55873E−11 |

PAN: the virgin membrane without NaOH treatment
PAN-OH: PAN virgin membrane treated with 1.5M NaOH for 1.5 hr at 45° C.
* Zeta potential at pH 5.5

Table 5 shows FO performance of the NF-like double-skinned FO membrane synthesized without crosslink post treatment 200-1. Test conditions: MgCl₂ as draw solution and DI water as feed solution at 23° C.

TABLE 5

| | | Jᵥ (Draw: | | Jᵥ (Draw: | | Jᵥ (Draw: | | Jᵥ (Draw: | | Jₛ/Jᵥ (Draw: | | Jₛ/Jᵥ (Draw: | | Jₛ/Jᵥ (Draw: | | Jₛ/Jᵥ (Draw: | |
|---|---|---|---|---|---|---|---|---|---|---|---|---|---|---|---|---|---|
| | | 0.5M MgCl₂) | | 1.0M MgCl₂) | | 2.0M MgCl₂) | | 3.0M MgCl₂) | | 0.5M MgCl₂) | | 1.0M MgCl₂) | | 2.0M MgCl₂) | | 3.0M MgCl₂) | |
| | | (L/m² · h) | | (L/m² · h) | | (L/m² · h) | | (L/m² · h) | | (×10⁻² M) | | (×10⁻² M) | | (×10⁻² M) | | (×10⁻² M) | |
| | Descrip- | AL- | AL- | AL- | AL- | AL- | AL- | AL- | AL- | AL- | AL- | AL- | AL- | AL- | AL- | AL- | AL- |
| | tion | DS | FW | DS | FW | DS | FW | DS | FW | DS | FW | DS | FW | DS | FW | DS | FW |
| 1 | 3-3′ LbL | 38.2 | 28.8 | 43.5 | 38.5 | 48.2 | 48.2 | 49.2 | 54.8 | 0.36 | 0.26 | 0.63 | 0.39 | 1.63 | 0.45 | 2.73 | 0.57 |
| | FO | | | | | | | | | | | | | | | | |

Jᵥ water flux; Jₛ/Jᵥ solute flux/water flux

Table 6 shows intrinsic separation properties of cross-linked NF-like double-skinned FO membrane 300-2a. Test conditions: 500 ppm MgCl₂ salt aqueous solution under 2.5 bar at 23° C. Pure water permeability coefficient (Aₚ) of PAN substrate was determined at an applied pressure of 2.5 bar using DI water as feed.

TABLE 6

| properties | 3-0 | 3-1 | 3-2 | 3-3 |
|---|---|---|---|---|
| PWP | 6.9 ± 1.6 | 5.9 ± 0.5 | 4.98 ± 1.6 | 3.2 ± 0.2 |
| (L m⁻²h⁻¹bar⁻¹) | | | | |
| Rej. (%) | 94.2 ± 0.7 | 95.5 ± 0.2 | 94.7 ± 0.1 | 93.2 ± 0.05 |
| Aₚ/10⁻¹¹ | 1.92 ± 0.2 | 1.6 ± 0.1 | 1.38 ± 0.4 | 0.89 ± 0.005 |
| (m · s⁻¹pa⁻¹) | | | | |
| B/10⁻⁷ | 1.2 ± 0.2 | 0.71 ± 0.001 | 0.71 ± 0.2 | 0.56 ± 0.004 |
| (m · s⁻¹) | | | | |

Table 7 shows FO performance of the NF-like double-skinned FO membranes 200-2a, 200-2b synthesized. Test conditions: MgCl₂ as draw solution and DI water as feed solution at 23° C.

TABLE 7

| | | Jᵥ (Draw: | | Jᵥ (Draw: | | Jᵥ (Draw: | | Jᵥ (Draw: | | Jₛ/Jᵥ (Draw: | | Jₛ/Jᵥ (Draw: | | Jₛ/Jᵥ (Draw: | | Jₛ/Jᵥ (Draw: | |
|---|---|---|---|---|---|---|---|---|---|---|---|---|---|---|---|---|---|
| | | 0.5M MgCl₂) | | 1.0M MgCl₂) | | 2.0M MgCl₂) | | 3.0M MgCl₂) | | 0.5M MgCl₂) | | 1.0M MgCl₂) | | 2.0M MgCl₂) | | 3.0M MgCl₂) | |
| | | (L/m² · h) | | (L/m² · h) | | (L/m² · h) | | (L/m² · h) | | (×10⁻² M) | | (×10⁻² M) | | (×10⁻² M) | | (×10⁻² M) | |
| | Descrip- | AL- | AL- | AL- | AL- | AL- | AL- | AL- | AL- | AL- | AL- | AL- | AL- | AL- | AL- | AL- | AL- |
| | tion | DS | FW | DS | FW | DS | FW | DS | FW | DS | FW | DS | FW | DS | FW | DS | FW |
| 1 | 3-0 LbL | 58.9 | 27.7 | 82.7 | 30.4 | 101 | 36.6 | 105 | 41.9 | 0.08 | 0.25 | 0.20 | 0.31 | 0.24 | 0.12 | 0.28 | 0.14 |
| | FO | | | | | | | | | | | | | | | | |
| 2 | 3-1 LbL | 77.0 | 35.2 | 88.9 | 39.1 | 106 | 49.8 | 109 | 52.4 | 0.29 | 0.35 | 0.35 | 0.35 | 0.51 | 0.42 | 0.58 | 0.34 |
| | FO | | | | | | | | | | | | | | | | |
| 3 | 3-2 LbL | 67.9 | 29.9 | 81.7 | 37.3 | 93.3 | 45.0 | 95.1 | 47.5 | 0.35 | 0.29 | 0.41 | 0.37 | 0.46 | 0.40 | 0.55 | 0.36 |
| | FO | | | | | | | | | | | | | | | | |
| 4 | 3-3 LbL | 42.3 | 26.3 | 49.4 | 31.1 | 56.6 | 38.8 | 62.3 | 39.9 | 0.49 | 0.55 | 0.55 | 0.49 | 0.58 | 0.49 | 0.83 | 0.52 |
| | FO | | | | | | | | | | | | | | | | |

Jᵥ water flux; Jₛ/Jᵥ solute flux/water flux

Table 8 shows FO performance of the RO-like double-skinned FO membrane synthesized. Test conditions: NaCl as draw solution and DI water as feed solution at 23° C.

TABLE 8

| | | Jᵥ (Draw: | | Jᵥ (Draw: | | Jᵥ (Draw: | | Jᵥ (Draw: | | Jₛ/Jᵥ (Draw: | | Jₛ/Jᵥ (Draw: | | Jₛ/Jᵥ (Draw: | | Jₛ/Jᵥ (Draw: | |
|---|---|---|---|---|---|---|---|---|---|---|---|---|---|---|---|---|---|
| | | 0.5M NaCl) | | 1.0M NaCl) | | 1.5M NaCl) | | 2.0M NaCl) | | 0.5M NaCl) | | 1.0M NaCl) | | 1.5M NaCl) | | 2.0M NaCl) | |
| | | (L/m² · h) | | (L/m² · h) | | (L/m² · h) | | (L/m² · h) | | (×10⁻² M) | | (×10⁻² M) | | (×10⁻² M) | | (×10⁻² M) | |
| | | AL- | AL- | AL- | AL- | AL- | AL- | AL- | AL- | AL- | AL- | AL- | AL- | AL- | AL- | AL- | AL- |
| | Description | DS | FW | DS | FW | DS | FW | DS | FW | DS | FW | DS | FW | DS | FW | DS | FW |
| 1 | 9-0 LbL FO | 15.9 | 14.7 | 23.2 | 17.5 | 30.1 | 19.7 | 36.7 | 22.5 | 2.07 | 1.22 | 2.24 | 1.31 | 2.85 | 1.63 | 3.0 | 1.92 |
| 2 | 9-9 LbL FO | 12.0 | 11.6 | 13.5 | 12.8 | 14.8 | 14.3 | 15.8 | 21.1 | 0.72 | 0.68 | 1.7 | 1.35 | 2.28 | 2.27 | 3.08 | 2.56 |

Jᵥ water flux; Jₛ/Jᵥ solute flux/water flux

### Example 4

Fouling test of single-skinned NF-like FO membrane 100 and double-skinned NF-like FO membrane 200 was performed. Fabrication and post-treatment process of membranes 100, 200 used in the fouling test are described in example 2 above. In this particular case, we compared with 3-0 LbL, 3-1 LbL and 3-3 LbL FO membranes.

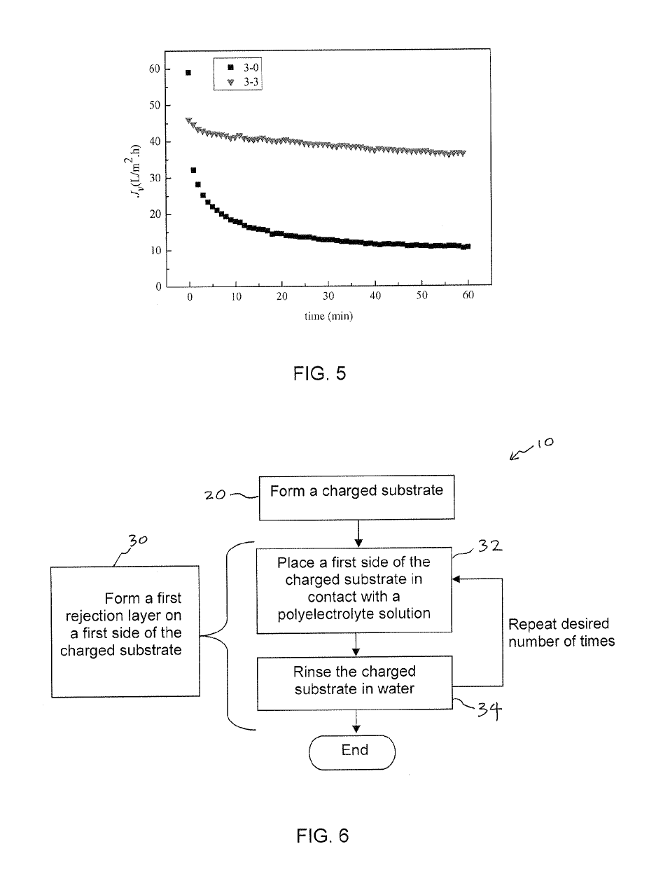

FIG. 5 shows the comparison of FO fouling of single-skinned (3-0 LbL) 100 and double skinned (3-3 LbL) 200 FO membranes (as prepared according to example 2). Test conditions are 0.5 M MgCl₂ as draw solution, and 300 ppm dextran (molecular weight ˜200-300 K) in pure water as feed solution. The double-skin FO membrane 200 showed dramatically improved flux stability over the single-skinned membrane 100.

The double-skinned FO membrane 200 has ultrathin and highly selective top layer 220 to achieve high water flux and high solute rejection and bottom loose selective layer 230 to avoid foulant penetrate into the porous support layer 210. At the same time, the very thin and porous support layer 210 eases ICP. On the other hand, a wide range of polymers can be used for substrate 210 fabrication, such as sulfonated polysulfone (PSF-SO₃), sulfonated polyether sulfone (PES-SO₃), Polyetherimide (PEI), polyacrylonitrile (PAN), polyamide (PA), poly-(ethylene terephthalate) (PET) and derivatives, etc. The rejection layer 220, 230 properties can be easily adjusted by changing the number of polyelectrolyte layers, LbL soaking conditions, and crosslinking conditions.

Therefore, the double-skinned FO membrane 200 can be potentially used for seawater desalination, wastewater treatment, food industry, as well as for electricity generation via a derivative pressure retarded osmosis process, etc.

Whilst there has been described in the foregoing description exemplary embodiments of the present invention, it will be understood by those skilled in the technology concerned that many variations in details of design, construction and/or operation may be made without departing from the present invention. For example, other aliphatic diamines may be used as the amine monomer for the interfacial polymerization step. Chemical post-treatment, such as acid/base wash or partial chlorination may be used to modify the cross-linking density of the selective rejection layer. Chemical pre-treatment, such as acid and/or base wash, may be used to modify substrate charged property. Membrane surface modification such as surface coating, plasma treatment, etc. may be performed as surface treatment can improve membrane rejection and surface properties in terms of hydrophilicity, surface charge, surface roughness and chemical resistance, etc. Incorporation of nano-particles, inorganic particles and water channels into the selective rejection layer or substrate may be carried out to improve membrane flux and rejection properties, and modify the structure. Hollow fiber membrane may be prepared using the above described method. The method may be combined with interfacial polymerization to form the selective rejection layer.

1. A method of forming a forward osmosis membrane, the method comprising the steps of:
a. forming a charged substrate;
b. forming a first rejection layer on a first side of the charged substrate, wherein forming the first rejection layer comprises
i. placing the first side of the charged substrate in contact with a polyelectrolyte solution; and
ii. rinsing the charged substrate in water.

2. The method of claim 1, further comprising repeating steps (b)i and (b)ii a number of times such that the first rejection layer formed comprises the number of multi-electrolyte layers.

3. The method of claim 1 wherein forming the charged substrate comprises forming a neutral substrate via phase inversion followed by treating the neutral substrate with a solution to form one of: a positively charged substrate and a negatively charged substrate.

4. The method of claim 1, wherein forming the charged substrate comprises forming one of: a positively charged substrate and a negatively charged substrate via phase inversion using one of: a positively charged polymeric material and a negatively charged polymeric material respectively.

5. The method of claim 1, wherein the polyelectrolyte solution comprises molecules capable of forming at least one of: strong intermolecular electrostatic interaction and hydrogen bonding.

6. The method of claim 5, wherein the molecules are selected from at least one of: poly(allylamin Hydrochlorid) (PAH), poly(sodium 4-styrene-sulfonate) (PSS), poly(methacrylic acid) (PMAA), poly(acrylamide) (PAAM), protonated polyvinylamine (PVA) and their derivatives.

7. The method of claim 1, wherein concentration of the polyelectrolyte solution ranges from 0.01 wt. % to 5 wt. %.

8. The method of claim 1, wherein ionic strength of the polyelectrolyte solution ranges from 0.1 wt. % to 2.0 wt. % and is adjusted by appropriate addition of an inorganic salt with a concentration ranging from 0 to 2.5M.

9. The method of claim 1, wherein forming the charged substrate comprises reinforcing the charged substrate with a fabric selected from one of: a woven fabric and a non-woven fabric.

10. The method of claim 1, further comprising the step of:
(c) forming a second rejection layer on a second side of the charged substrate, wherein forming the second rejection layer comprises
i. placing the second side of the charged substrate in contact with a polyelectrolyte solution; and
ii. rinsing the charged substrate in water.

11. The method of claim 10, further comprising repeating steps (c)i and (c)ii a number of times such that the second rejection layer formed comprises the number of multi-electrolyte layers.

12. The method of claim 10, further comprising a step of cross-linking at least one of: the first rejection layer and the second rejection layer.

13. A forward osmosis membrane formed according to the method of any preceding claim, the forward osmosis membrane comprising:
a charged substrate comprising finger-like pores; and
a first rejection layer comprising a number of multi-electrolyte layers formed on a first side of the charged substrate.

14. The forward osmosis membrane of claim 13 when dependent on claim 1, wherein the forward osmosis membrane has water permeability higher than 2×10⁻¹¹ m/s·Pa, salt permeability lower than 1.2×10⁻⁶ m/s when tested using 500 ppm MgCl₂ solution as a feed solution and a trans-membrane pressure of 689 kPa at 23° C.

15. The forward osmosis membrane of claim 14, wherein the forward osmosis membrane has a water flux higher than 20 L/m²·h and a salt flux lower than 4 g/m²·h when tested with 0 mM and 0.5M MgCl₂ solutions as a feed solution and a draw solution respectively at 23° C.

16. The forward osmosis membrane of claim 13 when dependent on claim 12, wherein the forward osmosis membrane has water permeability higher than 3×10⁻¹¹ m/s·Pa, salt permeability lower than 1.2×10⁻⁵ m/s when tested using 500 ppm MgCl₂ solution as a feed solution, and a trans-membrane pressure of 689 kPa at 23° C.

17. The forward osmosis membrane of claim 16, wherein the forward osmosis membrane has a water flux higher than 14 L/m²·h and a salt flux lower than 4.5 g/m²·h when tested with distilled water and 0.5M MgCl₂ solution as a feed solution and a draw solution respectively at 23° C.

18. The forward osmosis membrane of claim 13, wherein the rejection layer is less than 5 μm thick.

19. A forward osmosis membrane formed according to the method of claim 10, the forward osmosis membrane comprising:
a charged substrate comprising finger-like pores;
a first rejection layer comprising a number of multi-electrolyte layers formed on a first side of the substrate, and
a second rejection layer comprising a number of multi-electrolyte layers formed on a second side of the substrate.

20. The forward osmosis membrane of claim 19, wherein the first rejection layer is an ultrathin highly selective layer having high water flux and high solute rejection.

21. The forward osmosis membrane of claim 19, wherein the second rejection layer is a loosely selective layer configured to prevent foulant penetration into the substrate.

22. The forward osmosis membrane of claim 19, wherein the first rejection layer and the second rejection layer are less than 5 μm thick.
